(19) United States
(12) Patent Application Publication
(10) Pub. No.: US 2024/0079819 A1
(43) Pub. Date: Mar. 7, 2024

(54) BATTERY CHARGING CABLE ASSEMBLY

(71) Applicant: Brooke Erin DeSantis, Montreal (CA)

(72) Inventor: Alain Desmeules, Montreal (CA)

(73) Assignee: Brooke Erin DeSantis, Montreal (CA)

(21) Appl. No.: 17/939,119

(22) Filed: Sep. 7, 2022

(51) Int. Cl. H01R 13/62; H05B 6/10

(52) U.S. Cl. CPC H01R 13/6205; H05B 6/10

(57) ABSTRACT

A battery charging cable assembly for heated wearables is comprised of a first cable section having an input connector at one end for receiving a converted dc supply voltage. The first cable section is connected at another end to an input of an intelligent battery charger mounted in a housing. The housing has one or more output symmetrical female receptacle connectors for receiving a symmetrical male plug connector secured at one end of a respective one of two output charging cables. Each of the two output charging cables has a further symmetrical male plug connector or a magnetic male connector secured at an opposite end thereof for connection to a symmetrical female receptacle connector or female magnetic connector of a connecting port associated with a battery or battery pack to provide charging voltage and current thereto. The intelligent battery charger provides a rated charging voltage to each of said battery or battery pack while independently monitoring the battery capacity of the battery or battery pack.

### FIELD OF THE INVENTION

The present invention relates to battery charging cables for use to charge batteries of heated wearables and more specifically to a compact charging cable assembly having an intelligent battery charger provided with an input cable and one or two output charging cables which are equipped with symmetrical or magnetic connectors to facilitate connections to supply sources and battery charging ports.

### BACKGROUND OF THE INVENTION

When charging batteries of the type utilized with heated wearables, the power input is often required to be converted to a different power output that is specific to the type of battery being charged. For example, USBC protocol output is generally 5V, 9V and 12V and batteries need to be charged at 8.4V, 12.6V, etc. Therefore, the battery charging cable assembly would convert the power input from various power supply to be able to fit the power output required to charge a battery. The battery charging cable assembly may also be useful when the plug for the power input is different from the power output. For example, threw power output may be USBC male plug and the output plug to the battery may be a magnetic plug of the type as described in my co-pending U.S. patent application Ser. No. 17/581,891, filed on Jan. 22, 2022 and entitled “Control Device for Mounting on Electrically Heated Articles of Apparel”. The battery charging cable assembly is also useful to be able to split one input cable into two output cables, often required for a pair of heated socks or gloves.

Electrically heated wearables are provided with rechargeable batteries which are integrated with the wearables and usually stored in discrete pouches formed with the wearable or close-by in battery supports, such as a belt or a wearer person and usually in close proximity to the heated wearable where its charging cable can be concealed and not encumbering to the user person. These batteries once depleted of its charge requires recharging and most often this is accomplished at the premises of the wearer person. However, when the heated wearable is operational for long periods of time and the wearer person's premises or vehicle is not readily accessible, the heated wearable is no longer functional and this creates a discomfort for the user person, particularly when in a cold environment. To prevent such a situation the wearer person ideally carries a charging cable with power adapters to be able to charge the batteries. Such cable and adapters is encumbering to the wearer person. Additionally, a power outlet to plug the charger may not be available in public areas, such as ski resorts. There is therefore a need to provide a battery charging cable which is compact and easy to use but foremost compatible and easy to connect to power output with standard female ports such as standard USB, USB type C readily available in most of computers, power banks, cars, RV, hotels, coffee shops, public spaces, etc.

Battery charging cables to charge portable batteries of wearables are known but they are bulky and utilize connectors that are often difficult to connect to the charging ports of the batteries and the connecting ports of the adapters to the charging power source. These connectors require visual access for its connections as they can only be connected at a certain orientation, such as with the standard USB connector which is massive and which only plugs in one way, which is often never the correct orientation one tries to plug it in the first time even with visual access to the connector. There is therefore a need to provide a battery charging cable which facilitates the connections of the cable to the power source and the rechargeable batteries connectors.

There is also a need to provide a charging cable capable of transmitting both electrical power and data to an intelligent charger module in the charging cable and wherein the intelligent module is adapted to charge two or more batteries at the same time while independently monitoring the charge capacity of each battery and providing a signal to a user person when one or all of the batteries are fully charged.

There is a further need to have one universal charging cable to be able to be plugged in any power supply equipped with standard USB and/or USB type C female connectors. That way, the user can travel anywhere in the world and not have to worry about the power outlet plug type and voltage. It also allows for the manufacturer to avoid supplying the power supply itself along with the charging cable. The power supply is a standard piece found in profusion in most of the homes. It is therefore more ecological and economical not to supply the power supply.

There is a still further need to have one universal charging cable to be able to comply with new and forthcoming European laws to force electronic manufacturer to supply standard universal plugs to the customers. The battery charging cable would have an input plug complying with the universal standard.

### SUMMARY OF THE INVENTION

It is a feature of the present invention to provide a charging cable assembly for rechargeable portable batteries which provides all of the above needs of the current prior art and which is compact, easy to connect using a universal plug input, converting current from power input available to fixed battery current requirement and communicate visual signals of the charge state of more than one battery being charged.

Another feature of the present invention is to provide a battery charging cable assembly for rechargeable portable batteries which utilizes symmetrical connectors which are reversible making it easy for the user person to connect to power supply adapters and battery connectors.

Another feature of the present invention is to provide a charging cable assembly for rechargeable portable batteries which utilizes a quick connect magnetic connector at the battery connecting end of the output charging cable(s).

A further feature of the present invention is to provide a battery charging cable assembly for rechargeable portable batteries incorporating an intelligent battery charger having at least one output symmetrical female receptacle connector to which is connected a charging cable having symmetrical male connector which is a reversible connector and wherein the charging cable is also reversible.

A still further feature of the present invention is to provide a battery charging cable assembly for rechargeable portable batteries incorporating an intelligent battery charger having two output symmetrical female receptacle connectors to which are connected two charging cables each having symmetrical connectors at both ends which are reversible and wherein the charging cables are also reversible and interchangeable.

A still further feature of the present invention is to provide a battery charging cable assembly for rechargeable portable batteries incorporating an intelligent battery charger having two output symmetrical female receptacle connectors to which are connected two charging cables each having symmetrical connectors for connection the female symmetrical connectors of the intelligent battery charger and magnetic plug connectors at their opposed ends for quick connection the magnetic female connectors associated with batteries to be charged.

A still further feature of the present invention is to provide a battery charging cable assembly for rechargeable portable batteries which incorporates an intelligent battery charger capable of charging two or more batteries or battery packs at the same time and optionally independently monitoring the charge capacity of each battery and providing a visual signal to a user person when one or all of the batteries are fully charged.

According to the above features, from a broad aspect, the present invention provides a battery charging cable assembly for heated wearables. The battery charging cable assembly is comprised of a first cable section having an input connector at one end for connection to an ac adapter to receive a converted dc supply voltage. The first cable section is connected at another end to an input of an intelligent battery charger mounted in a housing. The housing has at least one output symmetrical female receptacle connector for receiving a symmetrical male plug connector secured at one end of the at least one output charging cable. The output charging cable has a further symmetrical male plug connector secured at an opposite end thereof for connection to a symmetrical female receptacle connector of a connecting port associated with a battery or battery pack to provide charging voltage and current. The at least one output charging cable is capable of supplying voltage from the intelligent battery charger to the battery or battery pack while the intelligent battery charger independently monitoring the battery capacity of the battery or battery pack.

According to the above features, from a further broad aspect, the present invention provides a battery charging cable assembly for heated wearables and comprised of a first cable section having an input connector at one end for connection to an ac adapter to receive a converted dc supply voltage. The first cable section being connected at another end to an input of an intelligent battery charger mounted in a housing. The housing has two output symmetrical female receptacle connectors for receiving a symmetrical male plug connector secured at one end of a respective one of two output charging cables. Each of the two output charging cables has a magnetic connector secured at an opposite end thereof for multi-directional magnetic coupling with a magnetic female receptacle connector of a connecting port associated with a battery or battery pack to provide charging voltage and current thereto. The two output charging cables are capable of supplying rated charging voltage between the intelligent battery charger and the battery or battery pack with the intelligent charger independently monitoring the battery capacity of each the battery or battery pack.

### BRIEF DESCRIPTION OF THE DRAWING

A preferred embodiment of the present invention will now be described with reference to the accompanying drawings in which:

FIG. 1 is a side view of the battery charging cable assembly of the present invention and showing a USBC ac adapter receptacle in which the USB type C male connector plug of the charging cable is connected to receive a converted dc supply voltage;

FIG. 2 is a top view of the battery charging cable assembly of FIG. 1;

FIG. 3 is an exploded and fragmented view of the battery charging cable assembly of the present invention;

FIG. 4 is an end view of the USBC type C connector illustrating the symmetrical configuration of the male connector plug;

FIG. 5A is a side view, similar to FIG. 1, of the battery charging cable assembly but wherein the outer end of the output charging cables are provided with magnetic connectors:

FIG. 5B is a top view of the battery charging cable assembly of FIG. 5A and

FIG. 6 is a perspective view illustrating the construction of a male magnetic connector of the type utilised at the free end of the output charging cables.

### DESCRIPTION OF THE PREFERRED EMBODIMENT

Before any embodiments of the application are explained in detail, it is to be understood that the application is not limited to the details of construction and the arrangement of component part set forth in the following description or illustrated by the following drawings. Further, it is to be understood that the phraseology and terminology used herein is for the purpose of description and should not be regarded as limiting but should encompass equivalents thereof.

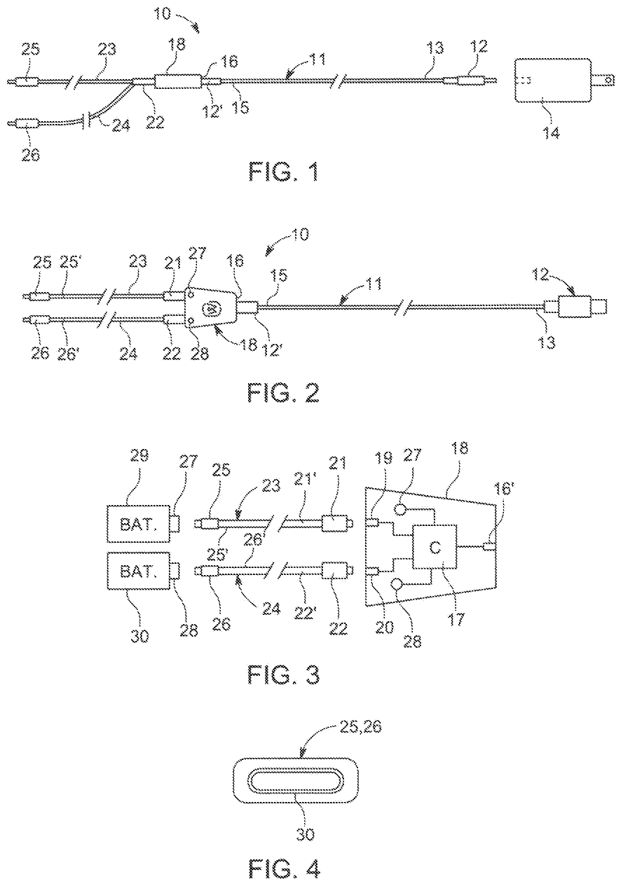

The invention will now be described with reference to the accompanying drawings. As shown in FIGS. 1 and 2, the battery charging cable assembly 10 was developed for charging rechargeable batteries used to provide power to electrically heating circuits of heated wearables, such as articles of apparel, gloves, socks, boots and shoes. The battery charging cable assembly 10 comprises a first cable section 11 provided with an input USB connector 12 at a free end 13 for connection to an ac adapter 14 to receive a converted dc supply voltage, for example, from a household supply of 112 volts, 60 cycle ac. The supply may also be provided by other power sources such as a cigarette lighter connector that we find in road vehicles. The first cable section 11 is connected at another end 15 to an input connection 16 of an intelligent battery charger 17, of a type known in the art, mounted in a charger housing 18. The first cable section 11 may be permanently secured to the charger housing 18 and the male input USB connector may be of several well-known types as well as the input female connector of the ac adapter 14 which connects to a standard 112 volt outlet.

The charger housing has at least one output symmetrical female receptacle connectors, herein two such connectors 19 and 20 for receiving a symmetrical USB male plug connector 21 and 22 secured at one end 21′ and 22′ of a pair of output charging cables 23 and 24. As herein illustrated, the charging cables 23 and 24 are further provided with a symmetrical USB male plug connector 25 and 26, respectively, secured at an opposite end 25′ and 26′. The connectors 21, 22, 25 and 26 are identical USB type C connectors. FIG. 4 illustrates the shape of a USB Type C plug connector 25 or 26 wherein it can be seen that the plug section 30 is of oblong shape and therefore symmetrical in configuration permitting it to be reversible to plug into a female Type C receptacle connector, also of oblong shape. The female receptacle connectors, or connection ports, 19 and 20 are also USB type C connection ports. The output charging cables 23 and 24 are of sufficient length to permit the connectors 25 and 26 to connect to respective connecting ports 27 and 28 associated with a battery or battery pack 29 and 30, respectively, to provide charging voltage and current. The two charging cables 23 and 24 are capable of supplying voltage/current between the battery or battery pack and the intelligent battery charger 17 which is programmed to detect battery types and voltage/current ratings and provide a rated charging voltage/current to the battery or battery pack while independently monitoring the battery capacity of the battery or battery pack being charged.

As shown in FIG. 2, the intelligent battery charger housing 18 is provided with a LED lights 27 and 28 which are visual charge indicator lights associated with respective ones of the output charging cables 23 and 24 to provide an indication to a user person that the charging voltage/current is present and also when the battery or battery pack being charged as reached full charge capacity by changing color. The embodiment herein described shows two output charging cables to charge batteries associated with articles that come in pairs, such as gloves, socks or shoes/boots, a single output cable may be provided. Also, the charging cables 23 and 24 may be permanently connected into a heated wearable. It is also important to note, that with respect to the illustrated embodiment of FIGS. 1 to 3, the present invention makes the connections of the output charging cables 100% fool proof between the intelligent charger and the batteries to be charged due to the use of connectors 21, 22, 25 and 26 being USB type C connectors which are reversible. Because the connectors are reversible, the charging cables 23 and 24 become interchangeable and also reversible thereby resulting in 100% fool-proof connectability. USB type C connectors are also small with respect to the massive industry standard USB types A and B connectors which only plugs in one way. The USB Type C connectors are also about ⅓ the size of the standard USB types A and B connectors and do not require visual access for its connection due to the feature of being reversible. They are also small enough to plug into super-thin mobile devices equipped with rechargeable battery or peripheral devices. The world industry standard is shifting to standardize with such tiny connectors due to its versability and tiny size to adapt to smaller size electronic devices and smart devices and it also reduces the problem of having to have loads of different USB cables with different connector shapes for your various devices.

The first cable section 11 may be a fixed cable section which is permanently secured at its end 15 to the intelligent battery charger housing 18 and provided with a symmetrical USB type C connector 12. The first cable section 11 may also be constituted as a detachable cable section having symmetrical male connectors 12 and 12′ at opposite ends. Accordingly, the intelligent battery charger input 16 would be a symmetrical female receptacle connector of the USB type C. Such is the preferred version of the charging cable of the present invention for the reason that the first cable section 11 becomes a reversible charging cable and provides an assembly which is entirely detachable making it more compact to package and store in a user's pocket.

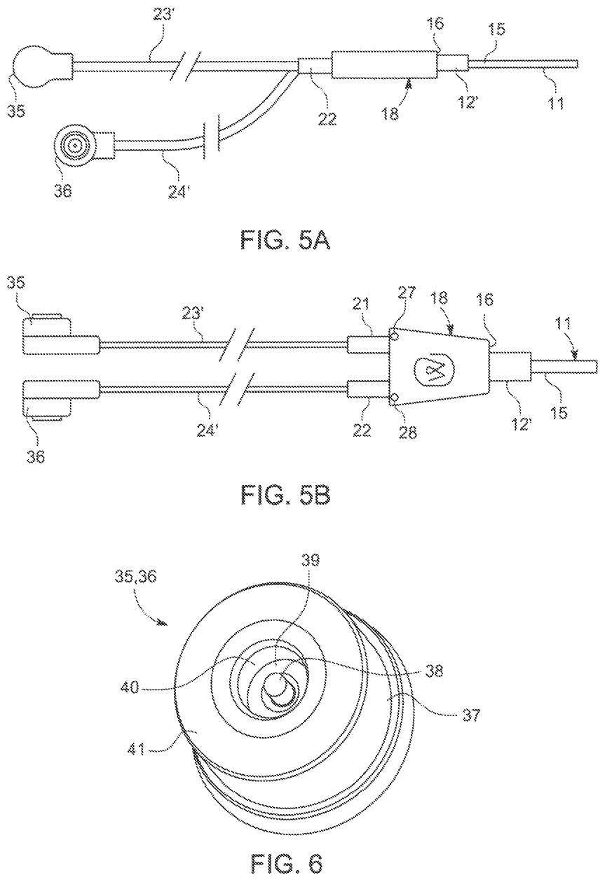

Referring now to FIGS. 5A and 58, there is illustrated a further modification of the output charging cables, herein cables 23′ and 24′ wherein their battery connecting free ends are provided with male type magnetic connectors 35 and 36. As mentioned herein above, these connectors form part of a co-pending application is herein incorporated by reference. As shown in FIG. 6, the magnetic male connectors 35, 36, are formed with a projecting cylindrical body portion 37 designed for close fit in a concave cylindrical housing of a female receptacle connector, not shown. A central electrical conductor coupling 38 projects from a bottom wall 39 of a hollow cavity 40 of the cylindrical body portion and surrounded at a top end by an electrically insulating second magnetically attractable flat metal surface 41 for multi-directional magnetic coupling over a female receptacle connector exhibiting a magnetic coupling force of a predetermined strength permitting rotational planar displacement of the cylindrical body 37 in a cylindrical retention housing when a shear force is applied thereto by the application of a pulling force on the conductor cable and without separating the magnetic coupling retention force between the magnetic connectors. It is pointed out that such connectors, like the USB Type C connectors do not require a specific orientation for coupling as it is only necessary to position the male connector over the female connector and the coupling is made by magnetic attraction force between the connectors.

Many modifications and other embodiments of the present invention as described above will come to mind to a person skilled in the art to which the invention pertains having the benefit of the teachings described herein above and the drawings. Hence, it is to be understood that the embodiments of the present invention are not to be limited to the specific examples thereof as described herein and other embodiments are intended to be included within the scope of the present invention and the appended claims. Although the foregoing descriptions and associated drawings describe example embodiments in the context of certain examples of the elements and members and/or functions, it should be understood that different combinations of elements or substitutes and/or functions may be provided by different embodiments without departing from the scope of the present invention as defined by the appended claims. Furthermore, although specific terms are employed herein, they are used in a generic and descriptive sense only and other equivalent terms are contemplated herein with respect to the items that they relate to. It is therefore within the ambit of the resent invention to encompass all obvious modifications of the examples of the preferred embodiment described herein provide such modifications fall within the scope of the appended claims.

1. A battery charging cable assembly for heated wearables, said battery charging cable assembly being comprised of a first cable section having an input connector at one end for connection to an ac adapter to receive a converted dc supply voltage, said first cable section being connected at another end to an input of an intelligent battery charger mounted in a housing, said housing having at least one output symmetrical female receptacle connectors for receiving a symmetrical male plug connector secured at one end of at least one output charging cable, said output charging cable having a further symmetrical male plug connector secured at an opposite end thereof for connection to a symmetrical female receptacle connector of a connecting port associated with a battery or battery pack to provide charging voltage and current, said at least one output charging cable being capable of supplying voltage from said intelligent battery charger to said battery or battery pack which is programmed to provide a rated charging voltage to said battery or battery pack while said intelligent battery charger independently monitors the battery capacity of said battery or battery pack.

2. The battery charging cable assembly for heated wearables as claimed in claim 1 wherein said housing is provided with two of said output symmetrical female connectors, and further wherein there are two of said output charging cables with each of said two output charging cables being connected to a respective one of said two output symmetrical female connectors and to associated ones of two of said battery or battery packs.

3. The battery charging cable assembly for heated wearables as claimed in claim 2 wherein said two output symmetrical female receptacle connector of said intelligent battery charger and said symmetrical male plug connector at said one end and opposite end of said two charging cables are USB type C connectors.

4. The battery charging cable assembly for heated wearables as claimed in claim 2 wherein said two output symmetrical female receptacle connector of said intelligent battery charger and said symmetrical male plug connector at said one end of said two charging cables are USB type C connectors and further wherein an opposite end of said output charging cables are provided with male magnetic connectors for multi-directional magnetic coupling with female magnetic connectors associated with said battery or battery pack to be charged.

5. The battery charging cable assembly for heated wearables as claimed in claim 3 wherein said intelligent battery charger housing is provided with a visual charge indicator associated with respective ones of said two charging cables to indicate the presence of charging voltage and/or a full charge capacity of said battery or battery pack associated therewith when connected thereto.

6. The battery charging cable assembly for heated wearables as claimed in claim 5 wherein said visual charge indicator is constituted by an LED light, said LED light when lite indicating that said battery or battery pack is fully charged.

7. The battery charging cable assembly for heated wearables as claimed in claim 2 wherein said further symmetrical male plug connector of each said two output charging cables are connectable to said battery or battery pack which is associated with each one of a pair of electrically heated gloves and a pair of electrically heated socks.

8. The battery charging cable assembly for heated wearables as claimed in claim 2 wherein said first cable section is a USB type C cable capable of transmitting voltage and data.

9. The battery charging cable assembly for heated wearables as claimed in claim 8 wherein said input connector of said USB type C cable is a symmetrical connector.

10. The battery charging cable assembly for heated wearables as claimed in claim 9 wherein said another end of said USB cable has a symmetrical connector for connection to an input symmetrical connector receptacle of said intelligent battery charger.

11. The battery charging cable assembly for heated wearables as claimed in claim 7 wherein said converted dc supply voltage is a 9 volts, 2 amps, supply voltage, said intelligent battery charger providing a power supply of 8.4 volts, 1.5 amps, at each said opposite end of said two output charging cables.

12. The battery charging cable assembly for heated wearables as claimed in claim 6 wherein said two output charging cables are permanently secured in a respective heated wearable.

13. The battery charging cable assembly for heated wearables as claimed in claim 3 wherein said two charging cables are reversible and interchangeable charging cables.

14. The battery charging cable assembly for heated wearables as claimed in claim 2 wherein said first cable section is a fixed cable section which is permanently secured at said other end to said input of said intelligent battery charger.

15. The battery charging cable assembly for heated wearables as claimed in claim 2 wherein said first cable section is a detachable cable section having symmetrical male connectors at opposite ends thereof, said intelligent battery charger input being constituted by a symmetrical female receptacle connector.

16. The battery charging cable assembly for heated wearables as claimed in claim 15 wherein said symmetrical connectors of said first cable section are USB type C connectors, said first cable section being a reversible charging cable.

17. A battery charging cable assembly for heated wearables and comprised of a first cable section having an input connector at one end for receiving a converted dc supply voltage, said first cable section being connected at another end to an input of an intelligent battery charger mounted in a housing, said housing having two output symmetrical female receptacle connectors for receiving a symmetrical male plug connector secured at one end of a respective one of two output charging cables, each of said two output charging cables having a magnetic connector secured at an opposite end thereof for multi-directional magnetic coupling with a magnetic female receptacle connector of a connecting port associated with a battery or battery pack to provide charging voltage and current thereto, said two output charging cables supplying rated charging voltage between the intelligent battery charger and the battery or battery pack with the intelligent charger independently monitoring the battery capacity of each said battery or battery pack.

18. The battery charging cable assembly for heated wearables as claimed in claim 17 wherein said female receptacle connectors of said housing and said symmetrical male plug connectors of said two output charging cables and USB Type C connectors.
